(19) United States
(12) Patent Application Publication
(10) Pub. No.: US 2011/0010466 A1
(43) Pub. Date: Jan. 13, 2011

(54) DYNAMIC CONTENT DELIVERY METHOD AND APPARATUS

(75) Inventors: Shunan Fan, Shenzhen (CN); Lei Wang, Shenzhen (CN); Ting Dong, Shenzhen (CN); Jian Yang, Shenzhen (CN); Guoqiao Chen, Shenzhen (CN); Huiping Zhang, Shenzhen (CN)

Correspondence Address: Docket Clerk/HTCL, P.O. Drawer 800889, Dallas, TX, 75380, US

(73) Assignee: Huawei Technologies Co., Ltd.

(21) Appl. No.: 12/887,357

(22) Filed: Sep. 21, 2010

Related U.S. Application Data
(63) Continuation of application No. PCT/CN2009/070765, filed on Mar. 12, 2009.

(30) Foreign Application Priority Data
Mar. 21, 2008 (CN) 200810084415.6

(51) Int. Cl. G06F 15/16

(52) U.S. Cl. 709/246

(57) ABSTRACT

The present invention relates to the communications field and discloses a DCD method and DCD apparatuses in order to solve the problem in the prior art that dynamic contents are delivered to the UE unselectively and this leads to failure of receiving or playing the dynamic contents subscribed to by the subscriber on the UE. The technical solution under the present invention is as follows: A DCD method includes filtering dynamic contents according to preset filtering information which includes dynamic content related information and/or filtering data information, where the filtering data information includes UE capability information and/or filtering policies. The technical solution under the present invention is applicable to a DCD system.

### CROSS-REFERENCE TO RELATED APPLICATIONS

This application is a continuation of International Application No. PCT/CN2009/070765, filed on Mar. 12, 2009, which claims priority to Chinese Patent Application No. 200810084415.6, filed on Mar. 21, 2008, both of which are hereby incorporated by reference in their entireties.

### TECHNICAL FIELD

The present invention relates to the communications field, and in particular, to a Dynamic Content Delivery (DCD) method and DCD apparatuses.

### BACKGROUND

DCD is a content service which is customizable and individualized to the subscriber. The service types provided by DCD include: mobile phone newspaper, advertisement, and mobile phone television. As shown in FIG. 1, a DCD system includes: a DCD content provider, a DCD server, and a User Equipment (UE) capable of the DCD function.

In the DCD system, the DCD content provider provides the channel contents for the DCD server. The DCD server is responsible for managing the channel contents, and providing the channel contents for the UE. The step of providing channel contents by the DCD server for the UE is: The DCD server sends a channel list to a subscriber; the subscriber subscribes to the desired channel from the channel list; and the DCD server sends the channel contents selected by the subscriber to the UE.

In the process of developing the present invention, the inventor finds at least the following problems in the prior art: The software and hardware configuration of the UE is limited. When the configuration required by the channel contents subscribed to by the subscriber is higher than the configuration of the UE, the UE may be unable to receive or play the channel contents normally. For example, the storage space of the UE is 2 M, when the channel contents subscribed to by the subscriber through clicking require a 10 M storage space, the UE is unable to receive the channel contents.

### SUMMARY

The embodiments of the present invention provide a method and apparatuses for distributing contents to control the dynamic contents available for subscription by the subscriber in light of the requirements of the UE.

In order to solve the technical problem above, one aspect of the present invention is to provide a DCD method. The method includes: filtering dynamic contents according to preset filtering information which includes dynamic content related information and/or filtering data information, where the filtering data information includes UE capability information and/or filtering policies.

In order to solve the technical problem above, another aspect of the present invention is to provide a DCD server, which includes:

a filtering information setting unit, configured to set filtering information for dynamic contents; and

a filtering unit, configured to filter the dynamic contents according to the filtering information;

In order to solve the technical problem above, another aspect of the present invention is to provide a UE, which includes:

a filtering data information setting unit, configured to set filtering data information for dynamic contents; and

a filtering unit, configured to filter the dynamic contents according to the filtering data information set by the filtering data information setting unit.

Through the DCD method and the DCD apparatuses disclosed herein, the dynamic contents can be delivered to the UE selectively according to the filtering information set for the dynamic contents at the time of providing dynamic contents for the UE. In this way, the problem in the prior art that dynamic contents are delivered to the UE unselectively and this leads to failure of receiving or playing the dynamic contents on the UE is solved, and thereby the dynamic contents delivered to the UE are controlled. Therefore, the dynamic contents delivered to the UE are more rationalized, and the experience of the subscriber using the DCD service is improved.

### BRIEF DESCRIPTION OF THE DRAWINGS

FIG. 1 shows a structure of a DCD system provided in the prior art;

FIG. 2 is a sequence diagram of a DCD method provided in the first embodiment of the present invention;

FIG. 3 shows a structure of a DCD server provided in the first embodiment of the present invention;

FIG. 4 shows a structure of a UE provided in the first embodiment of the present invention;

FIG. 5 is a sequence diagram of a DCD method provided in the second embodiment of the present invention;

FIG. 6 is a sequence diagram of a DCD method provided in the third embodiment of the present invention;

FIG. 7 is a sequence diagram of a DCD method provided in the fourth embodiment of the present invention;

FIG. 8 shows a structure of a DCD server provided in the fourth embodiment of the present invention;

FIG. 9 shows a structure of a UE provided in the fourth embodiment of the present invention;

FIG. 10 is a sequence diagram of a DCD method provided in the fifth embodiment of the present invention;

FIG. 11 shows a structure of a DCD server provided in the fifth embodiment of the present invention; and

FIG. 12 shows a structure of a UE provided in the fifth embodiment of the present invention.

### DETAILED DESCRIPTION

In order to solve the problem in the prior art that dynamic contents are delivered to the UE unselectively and this leads to failure of receiving or playing the dynamic contents subscribed to by the subscriber, the embodiments of the present invention provide a DCD method and DCD apparatuses. The present invention is elaborated below with reference to accompanying drawings and some exemplary embodiments.

A DCD method provided in an embodiment of the present invention includes:

filtering dynamic contents according to preset filtering information, where the filtering information includes dynamic content related information and/or filtering data information, and the filtering data information includes UE capability information and/or filtering policies.

When the filtering information is filtering policies, the operation of filtering dynamic contents according to the preset filtering information includes: comparing the dynamic contents with the preset filtering policies; and filtering the dynamic contents according to a comparison result.

When the filtering information is dynamic content related information and filtering policies, the operation of filtering dynamic contents according to the preset filtering information includes: comparing the dynamic content related information with the preset filtering policies; and filtering the dynamic contents according to a comparison result.

When the filtering information is dynamic content related information and UE capability information, the operation of filtering dynamic contents according to the preset filtering information includes: comparing the dynamic content related information with the UE capability information; and filtering the dynamic contents according to a comparison result.

A DCD server provided in an embodiment of the present invention includes:

a filtering information setting unit, configured to set filtering information for dynamic contents; and

a filtering unit, configured to filter the dynamic contents according to the filtering information.

A UE provided in an embodiment of the present invention includes:

a filtering data information setting unit, configured to set filtering data information for dynamic contents; and

a filtering unit, configured to filter the dynamic contents according to the filtering data information set by the filtering data information setting unit.

In the embodiments of the present invention, the dynamic contents include a channel list or channel contents; the dynamic content related information includes: information on the UE hardware required by the dynamic contents, or information on the UE software required by the dynamic contents, or User Agent Profile (UAProf)) information, or subscriber preference information, or subscriber level information, or information on content/channel metadata, or any combination thereof; the UE capability information includes UE hardware information, or UE software information, or UE version information, or any combination thereof; and the filtering policies include UAProf information, or subscriber preference information, or subscriber level information, or information on content/channel metadata, or any combination thereof. The filtering information given above is for the exemplary purpose only, and should not be construed as limitation in practical application.

The steps of the DCD method described above may be implemented by different network entities in the DCD system. The following describes the embodiments of the present invention in more detail, supposing that the dynamic contents are a channel list.

In the following embodiments, the UE includes a DCD client and DCD client applications.

### Embodiment 1

The DCD server generates information related to the channel content, and the DCD client filters the channel list according to the preset filtering data information and information related to the channel content.

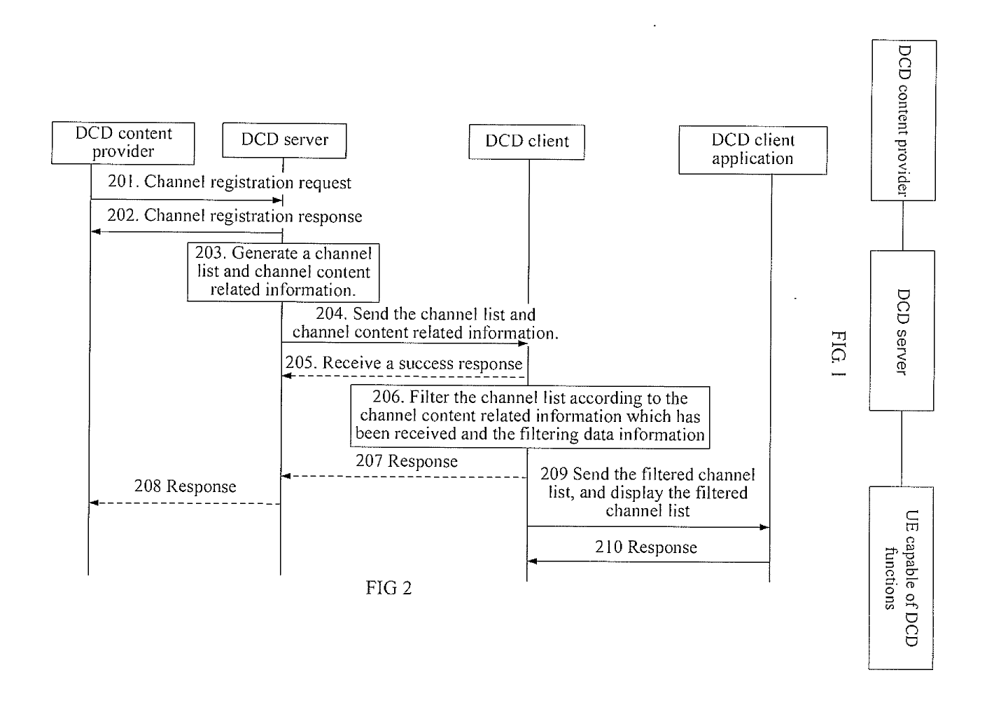

As shown in FIG. 2, the DCD method provided in this embodiment includes the following steps:

Step 201: A DOD content provider sends a channel registration request to the DCD server.

Step 202: The DCD server returns a channel registration response to the DCD content provider, and notifies the DCD content provider of the configuration information and activation state of channel registration on the DCD server.

Step 203: The DCD server generates a channel list according to the received channel contents, and generates information related to contents of each channel in the channel list respectively.

Table 1 shows the format of the information related to the channel content:

TABLE 1

| Information Element | Req | Type | Description |
|---|---|---|---|
| TargetProfileElement | Mandatory | String | Record the information |
| | | | related to the channel |
| | | | content |

In Table 1, “TargetProfileElement” is a customized element name. This element name reveals whether the information is related to the channel content. In this embodiment, the “TargetProfileElement” is for the exemplary only. In practical application, it may be the name of another element capable of the same function.

Step 204: The DCD server sends a channel list and the information related to the channel content to the DCD client.

In this embodiment, the DCD server can add the information related to the channel content into the channel list, and send it to the DCD client; or send the information related to the channel content as a separate information list to the DCD client.

When the DCD server sends the information related to the channel content as a separate information list to the DCD client, the information list may be transmitted through an existing DCD message such as ChannelDiscovery Info message, ChannelDiscovery Notification message, or Channel Update message; or may be transmitted through a customized message; or may be transmitted through a Push message directly.

Step 205: The DCD client returns a receiving success response to the DCD server after receiving the channel list and the information related to the channel content.

Step 206: The DCD client filters the channel list according to received information related to the channel content and filtering data information preset on the UE, including: comparing, by the DCD client, the preset filtering data information with the information related to the channel content, and filtering the channel list according to a comparison result. For example, if the filtering data information preset in the DCD client indicates that the UE can receive channel contents of 2 M or a smaller size, the DCD client compares the filtering data information with the received information related to the channel content, and deletes the channels whose size is greater than 2 M in the channel list.

Step 207: The DCD client may return a response to the DCD server, and the response carries a list of displayable channels.

Step 208: The DCD server may return a response to the DCD content provider, and the response carries the list of channels displayable on the UE.

Step 209: The DCD client sends the filtered channel list to a DCD client application, and the DCD client application displays the filtered channel list to the user.

In this step, the displaying of the filtered channel list by the DCD client application to the user may include: displaying, by the DCD client application, only the list of channels receivable by the UE to the user, or the list of all channels to the user, where this list indicates the channels receivable by the UE. The displaying method described above is for the exemplary purpose only. In practice, other displaying modes may be applied.

Step 210: The DCD client application returns a response to the DCD client.

In order to implement the DCD method disclosed herein, a DCD apparatus is provided in this embodiment. The DCD apparatus includes a DCD server and a UE.

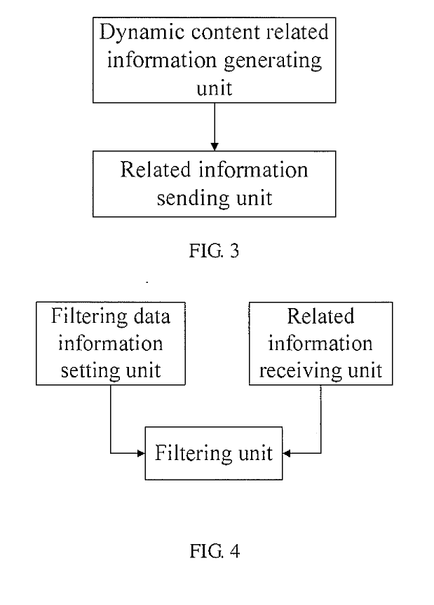

As shown in FIG. 3, a DCD server provided in this embodiment includes:

a dynamic content related information generating unit, configured to generate relevant information for the channel contents represented by the channel list; and

a related information sending unit, configured to send the information related to the channel content.

As shown in FIG. 4, a UE provided in this embodiment includes : a related information receiving unit, configured to receive the information related to the channel content sent by the DCD server;

a filtering data information setting unit, configured to set filtering data information for the channel contents; and

a filtering unit, configured to filter the channel contents represented by the channel list according to the information related to the channel content and the filtering data information.

The filtering by the filtering unit includes: when the filtering data information is UE capability information, comparing, by the filtering unit, the information related to the channel content with the UE capability information, and filtering the channel list according to the comparison result; and when the filtering data information is preset filtering policies, comparing, by the filtering unit, the information related to the channel content with the filtering policies, and filtering the channel list according to the comparison result.

In this embodiment, the dynamic contents can be channel contents. When the dynamic contents are channel contents, step 203 shown in FIG. 2 may skip the operation of generating the relevant information for the channel contents; in step 204, the DCD server sends only the channel contents to the DCD client; and in step 206, the DCD client may filter the channel contents according to the channel contents and preset filtering policies.

Through the DCD method and the DCD apparatuses disclosed in this embodiment, the DCD server may deliver dynamic contents to the UE selectively according to preset filtering information when providing dynamic contents for the UE. In this way, the problem in the prior art that a channel list or channel contents are delivered to the UE unselectively and this leads to failure of receiving or playing the channel contents subscribed to by the subscriber on the UE is solved, and the channel list or channel contents delivered to the UE are controlled. Therefore, the channel list or channel contents delivered to the UE are more rationalized, and the experience of the subscriber using the DCD service is improved.

### Embodiment 2

The DCD server generates information related to the channel content, and a DCD client application filters the channel list according to the preset filtering data information and the information related to the channel content.

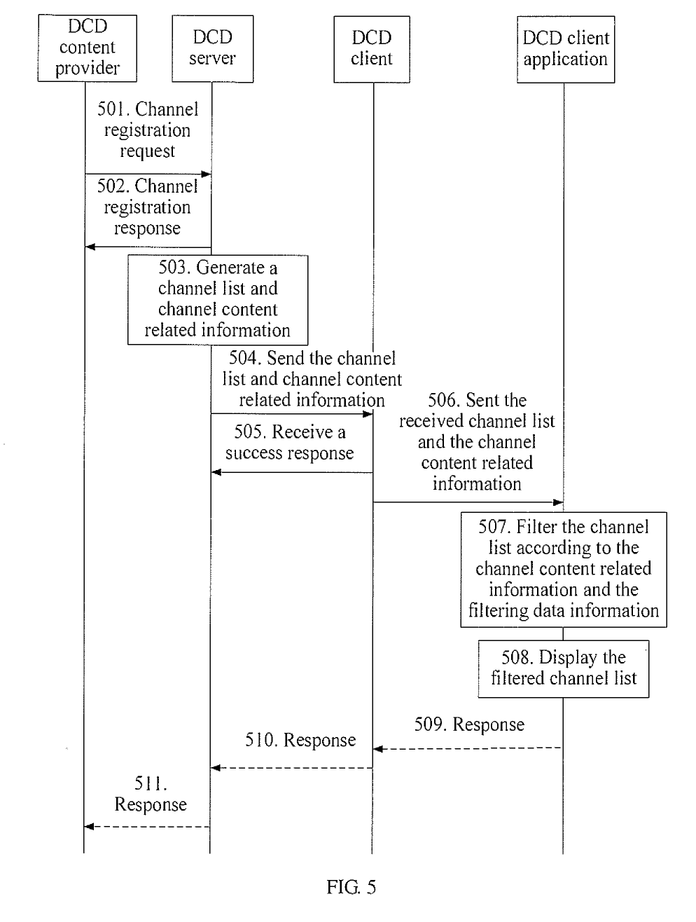

As shown in FIG. 5, in the DCD method provided in this embodiment, steps 501-505 are the same as steps 201-205 in FIG. 2, and are not repeatedly described here any further. The difference between this embodiment and the DCD method shown in FIG. 2 is as follows:

Step 506: The DCD client sends the received channel list and the information related to the channel content to the DCD client application.

Step 507: The DCD application filters the channel list according to the information related to the channel content and the preset filtering data information, where step 507 specifically includes: comparing, by the DCD client application, the preset filtering data information with the information related to the channel content, and filtering the channel list according to a comparison result.

Step 508: The DCD client application displays the filtered channel list to the subscriber.

In this step, the displaying of the filtered channel list by the DCD client application to the user may include: displaying, by the DCD client application, only the list of channels receivable by the UE to the user, or the list of all channels to the user, where this list indicates the channels receivable by the UE. The displaying method described above is for the exemplary purpose only. In practice, other displaying modes may be applied.

Step 509: The DCD client application may return a response to the DCD client, and the response carries a list of displayable channels.

Step 510: The DCD client may return a response to the DCD server, and the response carries a list of displayable channels.

Step 511: The DCD server may return a response to the DCD content provider, and the response carries the list of displayable channels.

In order to implement the DCD method disclosed herein, a DCD apparatus is provided in this embodiment. The DCD apparatus includes a DCD server and a UE and is the same as that in the first embodiment, and therefore is not repeatedly described here any further.

In this embodiment, the dynamic contents may be channel contents. When the dynamic contents are channel contents, the DCD client application may filter the channel contents according to the received channel contents and the preset filtering data information. The detailed operation is basically same with the first embodiment, and therefore is not repeatedly described here any further.

Through the DCD method and the DCD apparatuses disclosed in this embodiment, the DCD client application can receive channel contents or channel list provided by the DCD server selectively according to the preset filtering information. In this way, the problem in the prior art that a channel list or channel contents are delivered to the UE unselectively and this leads to failure of receiving or playing the channel contents subscribed to by the subscriber on the UE is solved, and thereby the channel list or channel contents delivered to the UE are controlled. Therefore, the channel list or channel contents delivered to the UE are more rationalized, and the experience of the subscriber using the DCD service is improved.

### Embodiment 3

The DCD content provider generates information related to the channel content, and the DCD client filters the channel list according to the preset filtering data information and the information related to the channel content.

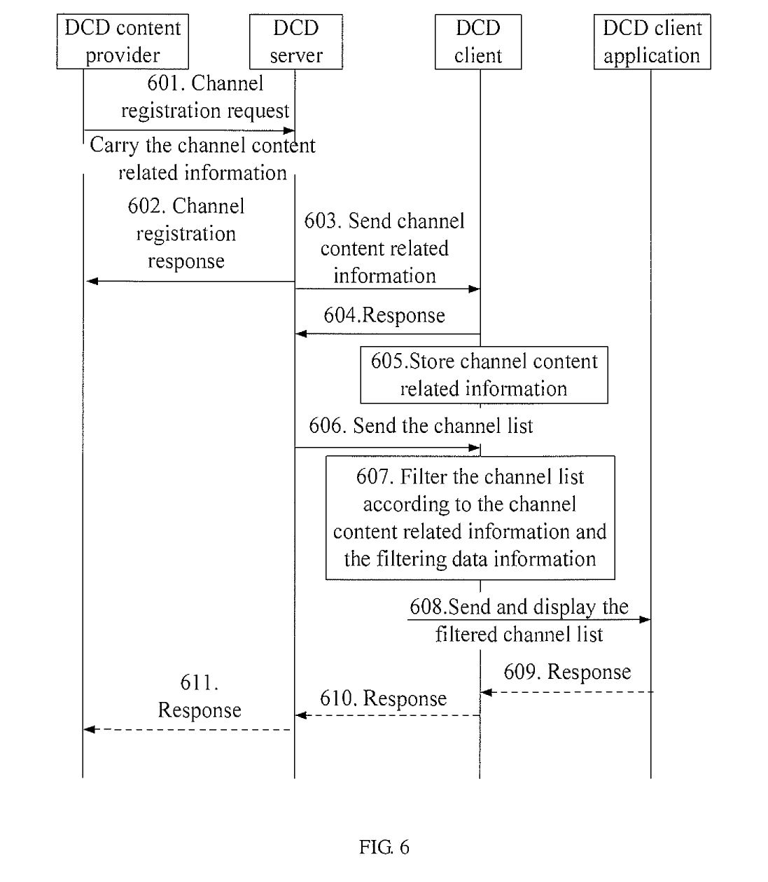

As shown in FIG. 6, the DCD method provided in this embodiment includes:

Step 601: The DCD content provider sends a channel registration request to the DCD server, and the channel registration request carries information related to the channel content. The information related to the channel content is provided by the DCD content provider for the DCD server. The format of the information related to the channel content is the same as that shown in Table 1, and is not repeatedly described here any further.

Step 602: The DCD server returns a channel registration response to the DCD content provider, and notifies the DCD content provider of the configuration information and activation state of channel registration on the DCD server.

Step 603: The DCD server sends the information related to the channel content received from the DCD content provider to the DCD client.

In this embodiment, the DCD server can send the information related to the channel content as a separate information list to the DCD client, the information list may be transmitted through an existing DCD message such as ChannelDiscovery Info message, ChannelDiscovery Notification message, or Channel Update message; or may be transmitted through a customized message; or may be transmitted through a Push message directly.

Step 604: The DCD client returns a receiving success response to the DCD server after receiving the information related to the channel content.

Step 605: The DCD client stores the information related to the channel content.

Step 606: When it is required to send the channel contents, the DCD server sends a channel list corresponding to the channel contents to the DCD clients.

Step 607: The DCD client searches for the information related to the channel content according to the received channel list and filters the channel list according to the preset filtering data information, where step 607 specifically includes: comparing, by the DCD client, the preset filtering data information with the found information related to the channel content, and filtering the channel list according to a comparison result.

Step 608: The DCD client sends the filtered channel list to a DCD client application, and the DCD client application displays the filtered channel list to the user.

In this step, the displaying of the filtered channel list by the DCD client application to the user may include: displaying, by the DCD client application, only the list of channels receivable by the UE to the user, or the list of all channels to the user, where this list indicates the channels receivable by the UE. The displaying method described above is for the exemplary purpose only. In practice, other displaying modes may be applied.

Step 609: The DCD client application may return a response to the DCD client, and the response carries a list of displayable channels.

Step 610: The DCD client may return a response to the DCD server, and the response carries a list of displayable channels.

Step 611: The DCD server may return a response to the DCD content provider, and the response carries the list of displayable channels.

In this embodiment, not only the DCD client can filter the channel list, but also the DCD client application can filter the channel list. When the DCD client application filters the received channel list, the principles are basically the same as those described in the second embodiment, and are not repeatedly described here any further.

In order to implement the DCD method disclosed herein, a DCD apparatus is provided in this embodiment. The DCD apparatus in this embodiment includes a UE, which is the same as the UE provided in the first embodiment, and is not repeatedly described here any further.

In this embodiment, the dynamic contents may be channel contents. When the dynamic contents are channel contents, the DCD content provider does not need to generate relevant information for the provided channel contents. The DCD client may filter the channel contents according to the received channel contents and the preset filtering data information.

Through the DCD method and the DCD apparatuses disclosed in this embodiment, the UE can filter the received channel list or channel contents according to the preset filtering information, and receive the channel contents selectively. In this way, the problem in the prior art that a channel list or channel contents are delivered to the UE unselectively and this leads to failure of receiving or playing the channel contents subscribed to by the subscriber on the UE is solved, and thereby the channel list or channel contents delivered to the UE are controlled. Therefore, the channel list or channel contents delivered to the UE are more rationalized, and the experience of the subscriber using the DCD service is improved.

### Embodiment 4

The DCD server generates information related to the channel content, and filters the channel list according to the preset filtering policies.

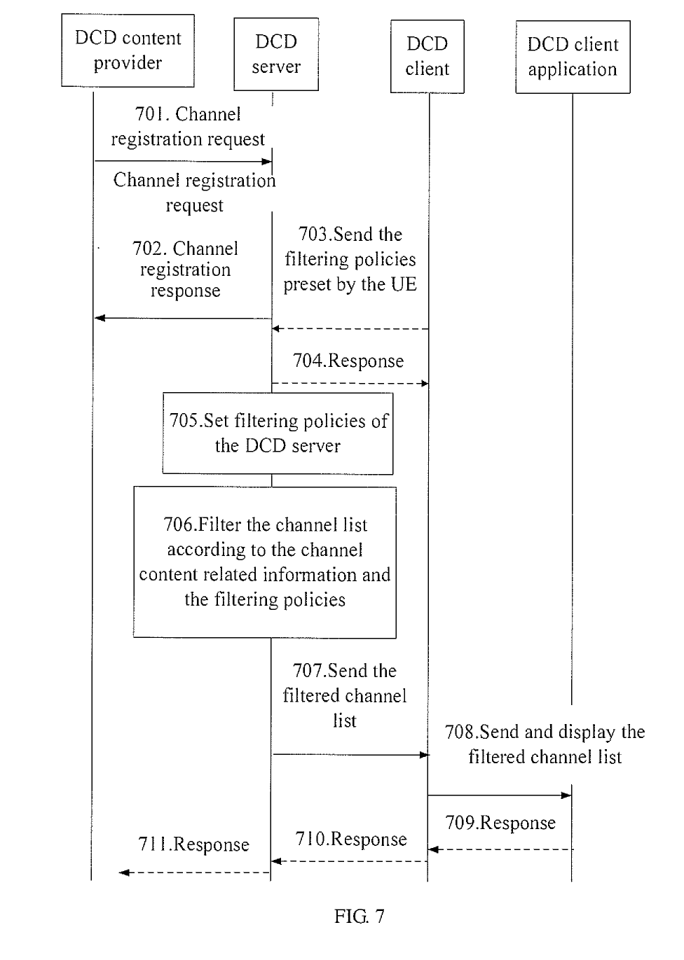

As shown in FIG. 7, the DCD method provided in this embodiment includes the following steps:

Step 701: The DCD content provider sends a channel registration request to the DCD server, and the channel registration request carries information related to the channel content. The information related to the channel content is provided by the DCD content provider for the DCD server. The format of the information related to the channel content is the same as that shown in FIG. 4 in the first embodiment, and is not repeatedly described here any further.

Step 702: The DCD server returns a channel registration response to the DCD content provider, and notifies the DCD content provider of the configuration information and activation state of channel registration on the DCD server.

Step 703 : The DCD client may send the filtering policies preset by the UE to the DCD server.

In this embodiment, there may be one or more filtering policies. The filtering policies may be set according to different channels or according to different subscribers of the service provided by the UE. Table 2 shows the filtering policies set by the UE according to different channels:

TABLE 2

| | | | Message | |
|---|---|---|---|---|
| Channel | Age | Trust list | size | Message type |
| Channel 1 | <18 | CCTV, yahoo | <2M | Text, picture, video, |
| | | | | audio |
| Channel 2 | >18 | Sina | <20M | Text |
| Channel 3 | <18 | CCTV | <200K | Text, picture |

The filtering policies may include: age, gender, and job of the subscriber, and may include a message and/or content related information, for example, upper threshold of the size of the received message, storage space of the UE, level of the message content, content format, and application level ID of the message, security level of the message source, and the keyword filtering of the content in the message.

The DCD client sends the filtering policies to the DCD server through a message such as Contextual Information Upload message, or Channel SubscriptionRequest message, or Content Update Request message, or through an extended FilterMessage. Filtering policies may be transmitted to the DCD server through a Hyper Text Transfer Protocol (HTTP) message directly. Table 3 shows an example of a message format for transmitting the filtering policies through an extended FilterMessage:

TABLE 3

| Information | | | |
|---|---|---|---|
| Element | Req | Type | Description |
| Message-Type | Mandatory | String | The message type indication is |
| | | | “FilterMessageRequest” |
| Message-ID | Mandatory | String | Identifying this message to |
| | | | facilitate filtering |
| Channel-IDs | Optional | String | Different filtering policies may be |
| | | | applied according to different |
| | | | channels |
| Content-IDs | Optional | String | Different filtering policies may be |
| | | | applied according to different |
| | | | contents |
| FilterElement | Mandatory | String | Specifying the filtering policies |

The message whose property is “FilterElement” is a customized message. In practical application, the message may be replaced with another message of DCD, and/or the message in Table 3 is reused. However, if another customized message is used instead, the property “FilterElement” needs to be reserved. In this embodiment, “FilterElement” is only an example. In practice, another property of the same filtering function may be used instead.

Step 704: After receiving the filtering policies, the DCD server stores the filtering policies set by the UE, and returns a receiving success response to the DCD client.

Step 705: The DCD server sets filtering policies for the channel contents. The filtering policies may be the same as or different from the received filtering policies of the UE.

Step 706: When channel contents need to be sent to the DCD client, the DCD server filters the channel list that represents the channel contents according to the UE filtering policies received in step 704, the filtering policies set by the DCD server in step 705, and the information related to the channel content obtained from the DCD content provider.

In this step, when the DCD server filters the channel list, a union set of all filtering policies of the UE and the filtering polices set by the DCD server may be obtained, and then the union set of the filtering policies is compared with the channel content information, and the channel list is filtered according to the comparison result. Alternatively, a union set of each filtering policy obtained from the UE and the filtering policies set by the DCD server is obtained respectively, and then the union set of the filtering policies is compared with the information related to the channel content, and the channel list is filtered according to the comparison result.

Step 707: The DCD server sends the filtered channel list to the DCD client.

Step 708: The DCD client sends the received channel list to a DCD client application, and the DCD client application displays the filtered channel list to the user.

In this step, the displaying of the filtered channel list by the DCD client application to the user may include: displaying, by the DCD client application, only the list of channels receivable by the UE to the user, or the list of all channels to the user, where this list indicates the channels receivable by the UE. The displaying method described above is for the exemplary purpose only. In practice, other displaying modes may be applied.

Step 709: The DCD client application may return a response to the DCD client, and the response carries a list of displayable channels.

Step 710: The DCD client may return a response to the DCD server, and the response carries a list of displayable channels.

Step 711: The DCD server may return a response to the DCD content provider, and the response carries the list of displayable channels.

In this embodiment, steps 703, 704, and 705 may occur before step 701, and the filtering policies set by the UE may be generated by the DCD client, or generated by the DCD client application.

In order to implement the DCD method disclosed herein, a DCD apparatus is provided in an embodiment of the present invention. The DCD apparatus includes a DCD server and a UE.

As shown in FIG. 8, a DCD server provided in an embodiment of the present invention includes:

a filtering information receiving unit, configured to receive filtering information, which, in this embodiment, includes information related to the channel content sent by the DCD server and the filtering policies set by the UE and sent by the DCD client;

a filtering information setting unit, configured to set the filtering policies of the DCD server, where the filtering policies may be the same as or different from the filtering policies set by the UE and received by the filtering information receiving unit; and

a filtering unit, configured to filter the channel list according to the information related to the channel content obtained from the DCD content provider and the filtering policies obtained by the filtering information receiving unit and the filtering information setting unit.

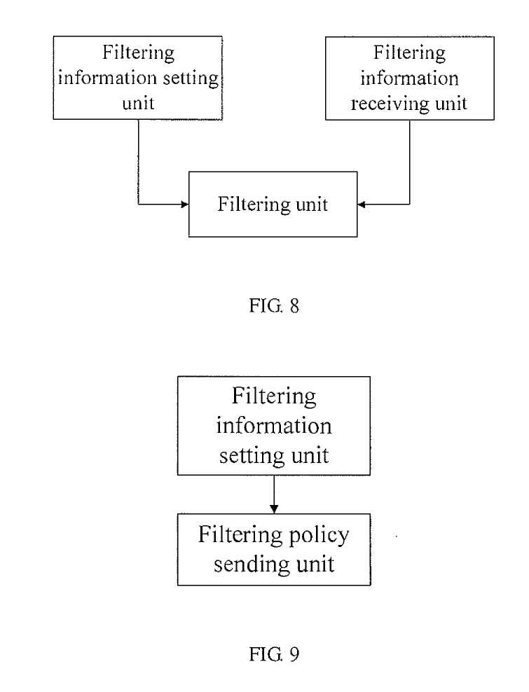

As shown in FIG. 9, a UE provided in this embodiment includes:

a filtering data information setting unit, configured to set filtering data information, which, in this embodiment, includes UE capability information and filtering policies; and

a filtering policy sending unit, configured to send the filtering policies set by the filtering information setting unit to the DCD server.

In this embodiment, the dynamic contents may be channel contents. When the dynamic contents are channel contents, the DCD server may filter the channel contents according to the received filtering policies of the UE, the filtering policies set by the DCD server, and the received channel contents.

Through the DCD method and the DCD apparatus provided in this embodiment, the DCD server can filter the channel contents or the channel list according to filtering information such as the filtering policies preset by the DCD server and the filtering policies preset by the UE. Therefore, the DCD server can provide DCD services for the UE selectively. The preset filtering policies ensure that the provided DCD services are more secure, overcome the problem in the prior art that the channel list or channel contents are delivered to the UE unselectively and this leads to failure of receiving or playing the channel contents subscribed to by the subscriber on the UE or leads to subscription to illegal information is solved, and thereby the channel list or channel contents delivered to the UE are controlled. The channel list or channel contents delivered to the UE are more rationalized, and the experience of the subscriber using the DCD service is improved.

### Embodiment 5

The DCD server generates information related to the channel content, and the DCD server and the DCD client filter the channel list according to the preset filtering policies.

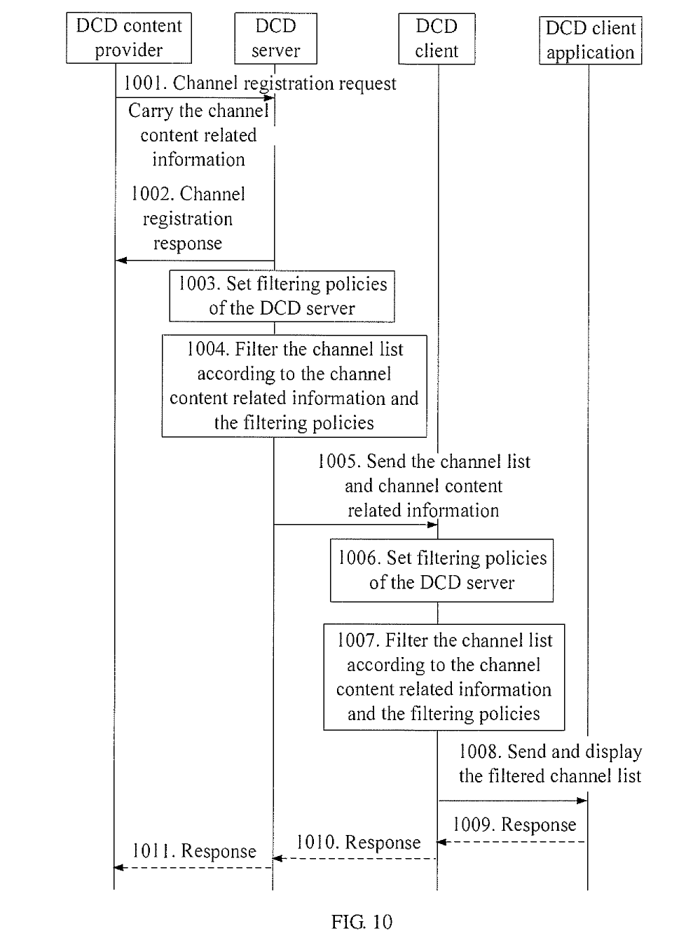

As shown in FIG. 10, the DCD method provided in this embodiment includes the following steps:

Step 1001: The DCD content provider sends a channel registration request to the DCD server, and the channel registration request carries information related to the channel content. The information related to the channel content is provided by the DCD content provider for the DCD server. The format of the information related to the channel content is the same as that shown in Table 1, and is not repeatedly described here any further.

Step 1002: The DCD server returns a channel registration response to the DCD content provider, and notifies the DCD content provider of the configuration information and activation state of channel registration on the DCD server.

Step 1003: The DCD server sets filtering policies for the channel contents.

Step 1004: When channel contents need to be sent to the DCD client, the DCD server filters the channel list that represents the channel contents according to the filtering policies set in step 1003 and the information related to the channel content obtained from the DCD content provider.

Step 1005: The DCD server sends the filtered channel list and the information related to the channel content to the DCD client.

Step 1006: The DCD client sets the filtering policy or policies. When the UE provides DCD services for multiple users simultaneously, different filtering policies maybe set for different users or according to different channels.

Step 1007: The DCD client filters the channel list according to the filtering policies set in step 1006 and the received information related to the channel content. The detailed operation is described in step 706 in FIG. 7, and is not repeatedly described here any further.

Step 1008: The DCD client sends the filtered channel list to a DCD client application, and the DCD client application displays the filtered channel list to the user.

In this step, the displaying of the filtered channel list by the DCD client application to the user may include: displaying, by the DCD client application, only the list of channels receivable by the UE to the user, or the list of all channels to the user, where this list indicates the channels receivable by the UE. The displaying method described above is for the exemplary purpose only. In practice, other displaying modes may be applied.

Step 1009: The DCD client application may return a response to the DCD client, and the response carries a list of displayable channels.

Step 1010: The DCD client may return a response to the DCD server, and the response carries a list of displayable channels.

Step 1011: The DCD server may return a response to the DCD content provider, and the response carries the list of displayable channels.

In this embodiment, the DCD server or DCD client may set the filtering policies at any time, and the description above is for the exemplary purpose only.

In order to implement the DCD method disclosed herein, a DCD apparatus is provided in this embodiment. The DCD apparatus includes a DCD server and a UE.

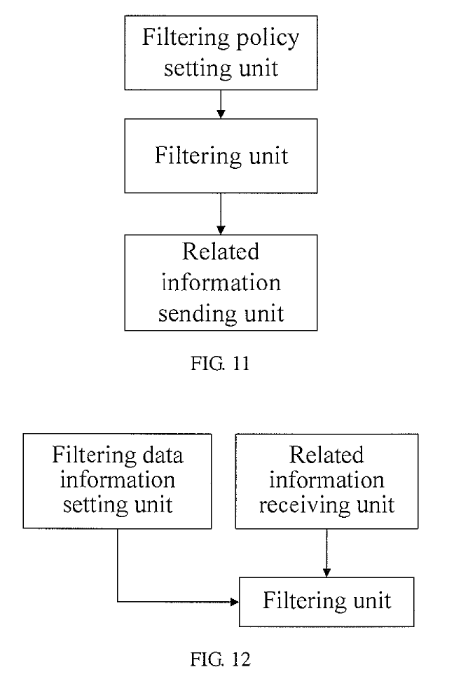

As shown in FIG. 11, a DCD server provided in this embodiment includes:

a filtering policy setting unit, configured to set filtering policies;

a filtering unit, configured to filter the channel list according to the information related to the channel content obtained from the DCD content provider and the filtering policies set by the filtering policy setting unit; and

a related information sending unit, configured to send the filtered channel list and the information related to the channel content to the DCD client.

As shown in FIG. 12, a UE provided in this embodiment includes:

a filtering data information setting unit, configured to set filtering data information;

a related information receiving unit, configured to receive the information related to the channel content sent by the DCD server; and

a filtering unit, configured to filter the received channel list according to the information related to the channel content received by the receiving unit and the filtering policies set by the filtering information setting unit.

In this embodiment, the dynamic contents may be channel contents. When the dynamic contents are channel contents, the DCD server and the DCD client may filter the channel contents according to the set filtering policies and the received channel contents.

Through the DCD method and the DCD apparatus provided in this embodiment, the DCD server and the UE can filter the channel contents or the channel list according to filtering information such as the preset filtering policies and the information related to the channel content. Therefore, the DCD server can provide DCD services for the UE selectively. The preset filtering policies ensure that the provided DCD services are more secure, overcome the problem in the prior art that the channel list or channel contents are delivered to the UE unselectively and this leads to failure of receiving or playing the channel contents subscribed to by the subscriber on the UE or leads to subscription to illegal information is solved, and thereby the channel list or channel contents delivered to the UE are controlled. The channel list or channel contents delivered to the UE are more rationalized, and the experience of the subscriber using the DCD service is improved.

The present invention is applicable to the DCD system for controlling the DCD services.

Person having ordinary skill in the art may understand that all or part of the steps of the method according to the embodiments of the present invention may be implemented by a program instructing relevant hardware. The program may be stored in a computer readable storage medium, such as a Read-Only Memory (ROM), a Random Access Memory (RAM), a magnetic disk or a Compact Disk Read-Only Memory (CD-ROM).

Detailed above are the technical solution, objectives and merits of the present invention. The above descriptions are merely some exemplary embodiments of the present invention, but not intended to limit the scope of the present invention. Any modification, equivalent replacement, or improvement made without departing from the spirit and principle of the present invention should fall within the scope of the present invention.

What is claimed is:

1. A Dynamic Content Delivery (DCD) method, comprising:
filtering the dynamic content according to preset filtering information, wherein: the filtering information comprises dynamic content related information or filtering data information; and the filtering data information comprises User Equipment (UE) capability information or filtering policies.

2. The DCD method according to claim 1, wherein:
the filtering information is the filtering policies, and the filtering of the dynamic contents according to the preset filtering information comprises: comparing the dynamic contents with the preset filtering policies; and filtering the dynamic contents according to a comparison result; or
the filtering information is the dynamic content related information and the filtering policies, the filtering of the dynamic contents according to the preset filtering information comprises: comparing the dynamic content related information with the preset filtering policies; and filtering the dynamic contents according to a comparison result; or
the filtering information is the dynamic content related information and the UE capability information, the filtering of the dynamic contents according to the preset filtering information comprises: comparing the dynamic content related information with the UE capability information; and filtering the dynamic contents according to a comparison result.

3. The DCD method according to claim 1, wherein the filtering of the dynamic contents according to the preset filtering information comprises:
discarding the dynamic contents which are not consistent with the preset filtering information.

4. The DCD method according to claim 2, wherein:
when the filtering information is the dynamic content related information and the filtering policies, before comparing the dynamic contents with the preset filtering policies, the method further comprises: receiving the dynamic content related information; or
when the filtering information is the dynamic content related information and the UE capability information, before comparing the dynamic content related information with the UE capability information, the method further comprises: receiving the dynamic content related information.

5. The DCD method according to claim 4, wherein:
a customized element name is set in the dynamic content related information, and serves as a basis for judging whether received information is the dynamic content related information.

6. The DCD method according to claim 2, wherein:
when the filtering information is the filtering policies, before comparing the dynamic contents with the preset filtering policies, the method further comprises a step of receiving the filtering policies; or
when the filtering information is the dynamic content related information and the filtering policies, before comparing the dynamic contents with the preset filtering policies, the method further comprises a step of receiving the filtering policies.

7. The DCD method according to claim 6, wherein:
a customized property is set in the filtering policies, and serves as a basis for judging whether received information is the filtering policies.

8. The DCD method according to claim 1, wherein:
the dynamic content related information comprises at least one of: information on UE hardware required by the dynamic contents, information on UE software required by the dynamic contents, User Agent Profile (UAProf) information, subscriber preference information, subscriber level information, and information on content/channel metadata.

9. The DCD method according to claim 1, wherein:
the filtering policies comprise at least one of:
User Agent Profile (UAProf) information, subscriber preference information, subscriber level information, and information on content/channel metadata.

10. The DCD method according to claim 1, wherein
the dynamic content is a channel list and the channel dynamic content related information is information related to contents of each channel in the channel list;
the filtering dynamic contents according to preset filtering information is: filtering the channel list according to filtering data information and information related to contents of each channel in the channel list.

11. The DCD method according to claim 10, wherein before filtering the channel list, the method further comprises:
receiving, by a DCD client, the channel list and the information related to contents of each channel in the channel list from a DCD server; and the filtering policies is preset information on channel metadata of channels in the channel list;
the filtering the channel list according to filtering data information and information related to content of each channel in the channel list comprises:
comparing, by the DCD client, the information on channel metadata with the information related to contents of each channel in the channel list; and
filtering the channel list according to a comparison result.

12. A Dynamic Content Delivery (DCD) server, comprising:
a filtering information setting unit, configured to set filtering information for dynamic contents; and
a filtering unit, configured to filter the dynamic contents according to the filtering information.

13. The DCD server according to claim 12, wherein the filtering information setting unit comprises:
a dynamic content related information generating unit, configured to generate dynamic content related information; and/or
a filtering policy setting unit, configured to set filtering policies for the dynamic contents; and
the filtering unit is further configured to compare the filtering policies with the dynamic content related information and filter the dynamic contents according to a comparison result.

14. The DCD server according to claim 12, further comprising:
a related information sending unit, configured to send the dynamic content related information.

15. The DCD server according to claim 14, wherein:
the related information sending unit is further configured to add the dynamic content related information into the dynamic contents for sending; or
the DCD server further comprises: a filtering information sending unit, configured to send the dynamic content related information as a separate related information list.

16. The DCD server according to claim 15, wherein:
the filtering information sending unit is further configured to send the dynamic content related information as a separate related information list through any one of a DCD service message, a customized message, and a Push message; and
the DCD service message is any one of a ChannelDiscovery Info message, or a ChannelDiscovery Notification message, or a Channel Update message.

17. The DCD server according to claim 12, further comprising:
a filtering information receiving unit, configured to receive the filtering information; and
a filtering unit, configured to filter the dynamic contents according to the received filtering information and the filtering information set by the filtering information setting unit.

18. A User Equipment (UE), comprising:
a filtering data information setting unit, configured to set filtering data information for dynamic contents; and
a filtering unit, configured to filter the dynamic contents according to the filtering data information set by the filtering data information setting unit.

19. The UE according to claim 18, further comprising:
a related information receiving unit, configured to receive dynamic content related information, wherein the filtering unit filters the dynamic contents according to the dynamic content related information and the filtering data information.

20. A User Equipment (UE) for filtering a dynamic content, wherein the dynamic content is a channel list, the UE comprises at least one component, and the at least one component is configured to:
receive the channel list and information related to contents of each channel in the channel list from a DCD server;
compare preset information on channel metadata of channels in the channel list with the information related to contents of each channel in the channel list; and
filter the channel list according to a comparison result.
